(19) United States
(12) Patent Application Publication
(10) Pub. No.: US 2006/0008609 A1
(43) Pub. Date: Jan. 12, 2006

(54) Sandwich panel and method of manufacturing same

(76) Inventors: Glenn E. Snyder, Quincy, MI (US); Keith R. Boyle, Hillsdale, MI (US); Willard E. Crotty III, Quincy, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/043,248

(22) Filed: Jan. 26, 2005

Related U.S. Application Data
(60) Provisional application No. 60/539,517, filed on Jan. 26, 2004.

(51) Int. Cl. B32B 3/10; B32B 7/08; B32B 29/00; B32B 23/04

(52) U.S. Cl. 428/44; 428/318.4; 428/532; 428/52

(57) ABSTRACT

A sandwich panel having a pair of skins and an intermediate substrate secured between the two skins creating a structural panel. The skins may be a pressboard material and a covering material may be applied to the skins forming an exterior surface. Selectively, the skins may be covered with a material. Further, an edge member may be provided that is engaged around the peripheral edge of the intermediate substrate. The edge member may include an engaging member and the engaging member may include anti-reverse fins. The edge member may also trap the covering material. A method of manufacturing a sandwich panel for an automobile where two skins of predetermined size and shape are provided. The two skins are attached to each other forming a structural panel. An intermediate substrate may be provided and attached between the skins. Further, an edge member may be provided and attached to the periphery of the structural panel.

### CROSS REFERENCE TO RELATED APPLICATIONS

This application claims the benefit of U.S. Provisional Application No. 60/539,517 filed Jan. 26, 2004, the entire contents of which are herein incorporated by reference.

### BACKGROUND OF THE INVENTION

1. Field of the Invention

The present invention relates to a sandwich panel and method of manufacturing a sandwich panel and, more particularly, to a sandwich panel and method of manufacturing a sandwich panel for use as a structural member.

2. Description of the Related Art

Load panels are used for covering storage areas and supporting weight in applications such as automotive interiors and storage spaces. Common uses include load floors, bay covers, flipper panels, seat backs, and cargo cabinets. Solid material panels are used for typical load panels in addition to blow molded panels.

A known prior art load panel is shown in FIGS. 1 and 2. FIG. 1 illustrates a typical single layer structural panel 20 in a closed position. Such a structural panel is integrated with an automobile floor 22 or side panel of an automobile. In the closed position, structural panel 20 is received by a support space 24. Structural panel 20 may be held in place by hinges 26, 28 and latches 30, 32. Latches 30, 32 may unlock structural panel 20 from support space 24. After unlocking, structural panel 20 may be opened to expose a cavity 33 defined by support space 24. FIG. 1 illustrates a system using latches 30, 32 and hinges 26, 28. FIG. 2 illustrates a typical structural panel 20 in an open position. Panel 20 has been folded back to expose support space 24 and cavity 33.

However, typical load panels have undue flex when supporting large weights. Additionally, typical panels do not maintain their desired shape under changes in atmospheric conditions such as temperature and humidity. The typical solid or single layer panels do not have the rigidity or atmospheric stability required for the harsh automotive environment. Additionally, typical panels do not include finished edges or edges that trap covering material at the edges to reduce peeling or separation of covering material.

Accordingly, a panel and method of manufacturing a panel is required that has improved strength, stiffness, dimensionally stability under various atmospheric conditions, provides expanded covering solutions, reduces costs for attachment devices installed during manufacture, and provides the option of trapping carpet fibers used as covering. More particularly, a panel is needed that provides for an improved panel for use as a structural member in, among other applications, automotive interior components, such as cargo trays, load floors, bay covers, flipper panels, seat backs, cargo cabinets and the like.

### BRIEF SUMMARY OF THE INVENTION

The present invention provides a structural panel and a method of manufacturing a structural panel. An embodiment comprises two skins attached to each other forming a structural panel. Another embodiment comprises two skins attached to an intermediate substrate forming a structural panel. Each skin may be made of a pressboard material. The skins may be attached to the intermediate substrate using adhesives or other attachment methods. Further, a covering material may be selectively applied to the skins.

Another embodiment comprises two skins attached to an intermediate substrate forming a structural panel further including an edge member. The edge member may include an engaging member that mechanically engages the intermediate substrate. The engaging member may also have anti-reverse fins that prevent the engaging member from backing out of the intermediate substrate. Further, a covering material may be selectively applied to the skins for improved reliability or for cosmetic appearance. The edge member may also trap a portion of the covering material to improve reliability and improve fit and finish of the panel.

The present invention also provides a method for manufacturing the sandwich panel for an automobile where two skins of predetermined size and shape are provided and attached to each other forming a structural panel. An intermediate substrate may also be provided and attached between the skins. The skins and intermediate substrate may be attached using adhesives or other fasteners. Further, additional hardware such as handles, connectors or the like, may be installed onto the panel. Another method of manufacturing the sandwich panel includes an edge member applied to the periphery of the structural panel.

### BRIEF DESCRIPTION OF THE DRAWINGS

Embodiments of the invention will now be described, by way of example, with reference to the accompanying drawings, wherein:

FIG. 1 is a perspective view of a general representation of a generic conventional structural panel in a closed position;

FIG. 2 is a perspective view of a general representation of a generic conventional structural panel in an open position;

FIG. 3 is a cross sectional view of a two layer sandwich panel according to an embodiment of the present invention;

FIG. 4 is a cross sectional view of a multilayer sandwich panel according to an embodiment of the present invention;

FIG. 5 is a cross sectional view of a multilayer sandwich panel including edging according to an embodiment of the present invention;

FIG. 6 is a deflection graph comparing a sandwich panel according to an embodiment of the present invention to a prior art panel;

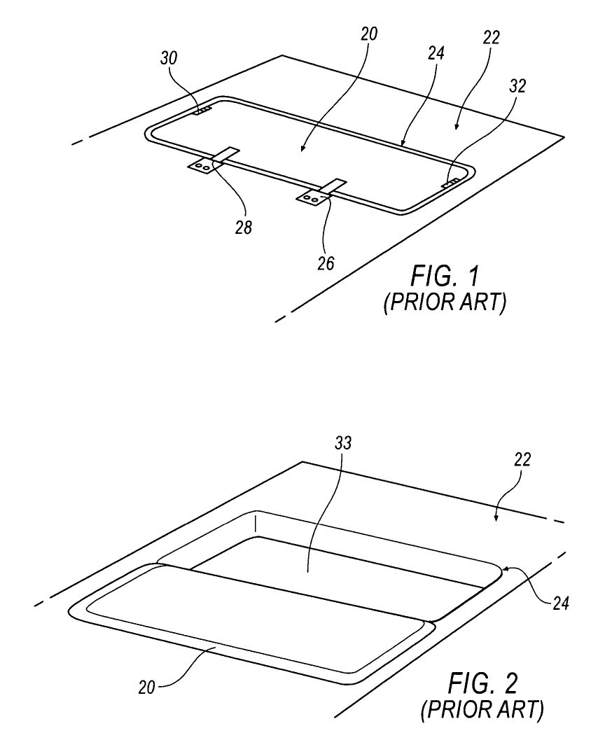

### DETAILED DESCRIPTION

Referring now to the drawings, the preferred illustrative embodiments of the present invention are shown in detail. Although the drawings represent some preferred embodiments of the present invention, the drawings are not necessarily to scale and certain features may be exaggerated to better illustrate and explain the present invention. Further, the embodiments set forth herein are not intended to be exhaustive or otherwise limit or restrict the invention to the precise forms and configurations shown in the drawings and disclosed in the following detailed description.

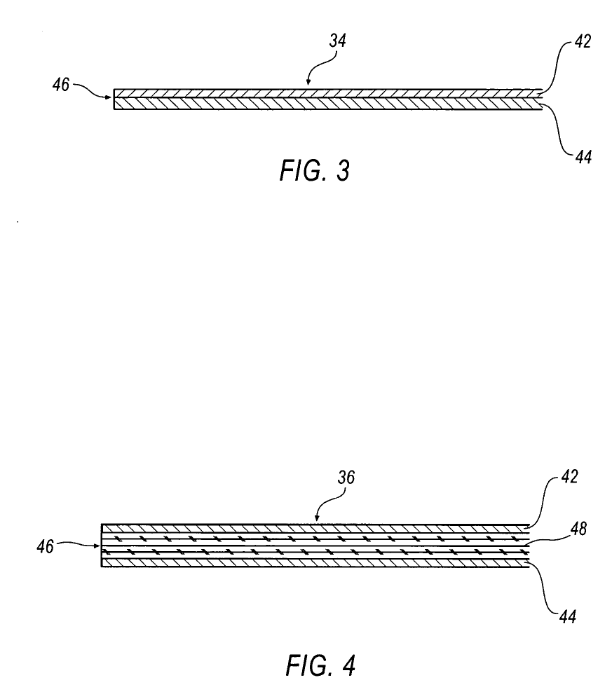

FIG. 3 illustrates a cross sectional view of a two layer sandwich panel 34 according to an embodiment of the present invention. Panel 34 includes at least two substrates or skins 42, 44. The skins 42, 44 may be fixed to one another using adhesive or other fastening methods. The sandwich of skins 42, 44 improves the strength, stiffness, and dimensional stability of the panel over various atmospheric conditions. The shape of each skin 42, 44 is defined by a peripheral edge 46 sized or otherwise configured to fit within or mate with an intended support space 24 (as shown in FIG. 2). Skins 42, 44 may be made of a pressboard-like material, such as “SUPERWOOD®,” (a registered trademark of Georgia Pacific Corporation), which is a type of hardboard. However, other materials, such as plastics, may also be employed in skins 42, 44.

FIG. 4 illustrates a cross sectional view of a multilayer sandwich panel 36 according to an embodiment of the present invention. Sandwich panel 36 has a third substrate or center layer 48 disposed between two outer skins 42, 44. The addition of center layer 48 provides additional structural integrity to sandwich panel 36. Center layer 48 may be made of any one or combination of wood, cardboard, plastic, metal, expanded or non expanded foam, and other structural materials. The skins 42, 44 may be fixed to center layer 48 using adhesive or other fastening methods. One or more additional intermediate layers may be added to the illustrated panel without departing from the scope of the invention.

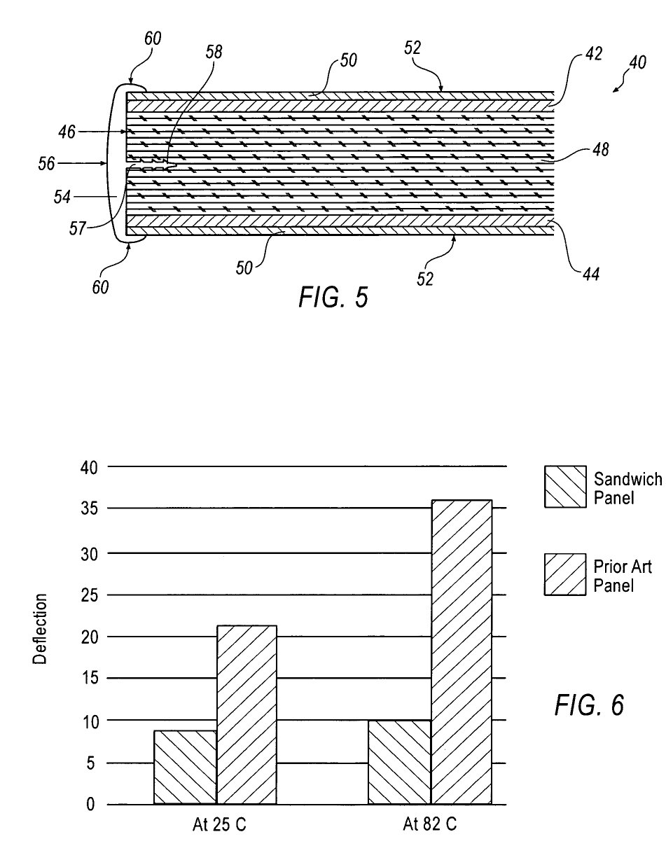

FIG. 5 illustrates a cross sectional view of a multilayer sandwich panel 40. Panel 40 includes at least three layers; a first outer skin 42, a center layer 48, and a second outer skin 44. Skins 42, 44 are secured to the center layer 48 using adhesives or other fastening methods. One or more additional intermediate layers may be added to the panel without departing from the scope of the invention.

When panel 40 is received in an automotive interior, for example, skins 42, 44 may be formed to match not only the peripheral shape of the area into which panel 40 may be received, but also the contour thereof. The contours may include a complex shape of an interior wall, or, for example, a bulge, pocket, or recess in an otherwise flat panel. Because skins 42, 44 may be made of a pressboard-type material, such as SUPERWOOD®, panel 40 may be molded in a heated press to conform to the shape of the receiving environment or to provide additional structural rigidity through predetermined structural formations, such as folds, bends and pockets. Among other benefits, panel 40 is dimensionally stable under various atmospheric conditions.

Panel 40 may also be aesthetically configured to provide an attractive outward appearance to complement the décor of the automobile interior. For example, skins 42, 44 may be covered with an upholstery material or painted to match the décor of a vehicle interior. Panel 40 allows for unique covering solutions, particularly when compared to similar non-sandwich products. Depending upon predetermined design considerations, one or both sides of panel 40 may be covered with a covering material 50, such as upholstery, carpet, leather, rubber or the like. If applied, covering material 50 then forms an exterior surface 52 of panel 40.

As illustrated in FIG. 5, an edge member 54 may be applied around at least a portion of the edges of panel 40. Edge member 54 may be applied to the entire periphery of panel 40, or edge member 54 may be applied only to a portion of the edges of panel 40. As edge member 54 forms to shape of the peripheral edge 46, panel 40 and outer peripheral edge 56 must be configured appropriately to be received by the intended support space. The thickness and cross-sectional profile of edge member 54 may be varied to tailor the edge strength of the panel, facilitate alignment of the panel with mating components in a vehicle, and serve as an anchor to interface with attachment hardware in the vehicle.

In the embodiment shown in FIG. 5, panel 40 incorporates an edge member 54 applied to the edges of the panel 40 (similar to the finishing on a table or desk edge). The edge member 54 generally provides a durable outer peripheral edge 56 that reduces warranty costs to the OEM and the manufacturer for damaged panels because, among other things, the edge member 54 protects the panel 40 from damaged during use. Edge member 54 may also provide a more refined appearance to the load panel and may be configured to match the interior or trim pieces of the vehicle.

In a particular implementation, edge member 54 includes an extruded plastic or vinyl cap having an engaging member 57 with anti-reverse fins 58. Fins 58 extend outwardly from engaging member 57 to grip center layer 48. Fins 58 may be configured to allow for easy insertion of the engaging member 57 with center layer 48, and may also be configured to prevent extraction of engaging member 57 from center layer 48 once installed. Once engaged in panel 40, fins 58 prevent the edge member 54 from releasing from the engaging substrate. Thus, anti-reverse fins 58 firmly hold edge member 54 to the panel 40. Other ways of securing edge member 54 to panel 40, such as adhering edge member 54 to panel 40, are also within the scope of the invention.

Edge member 54 may also include edge(s) 60 that trap covering material 50 and allow the panel to meet or exceed standards for fit, finish and safety, among other things. Among other benefits, edge member 54 allows for a professionally finished edge with less labor and/or material than typical pinch trimmed or edge folded panels. Edge member 54 may also trap the covering material 50 under its edge preventing the covering material 50 from delaminating from the skin(s) 42, 44.

Panel 40 may also be fitted with various devices such as handles, connectors or the like, which may be used with the panel 40 in its installed environment. The devices may be secured or attached to panel 40 in a number of ways, including, without limitation, adhering, screwing, riveting, and using an engaging member with anti-reverse fins 58 similar to that shown in FIG. 5. With the disclosed panel design, latch and hinge installation improvements for weight and cost savings are practical.

FIG. 6 illustrates a deflection graph comparing a sandwich panel according to an embodiment of the present invention to a prior art panel. In one particular implementation of the invention, panel 40 is used as a load-floor in the interior of an automobile. Such load-floors may be used to cover a spare tire in the vehicle or as a door to a storage compartment. In a particular load-floor application, the deflection of a load-floor employing panel 40 of the present invention was compared to a prior art automotive load-floor at 25° C. and 82° C. The prior art load-floor exhibited a greater deflection for a given load than did the load-floor employing panel 40 at both 25° C. and 82° C.

It will be appreciated that panel 40 is not limited to use as a load-floor in a vehicle. Among other applications, panel 40 may be used in a number of automotive interior components, such as cargo trays, load floors, bay covers, flipper panels, seat backs, cargo cabinets or the like. Further, panel 40 may be used in a number of non-automotive applications, particularly where a recyclable, formable structural member is desired.

A method for manufacturing panels according to embodiments of the present invention will now be described. Skins 42, 44 are cut to the appropriate dimension and, optionally, molded or formed under heat and/or pressure to create the desired shape of the panel. The optional intermediate substrate or center layer 48 is secured between skins 42, 44 prior to or after the covering material 50 is applied to skins 42, 44 (if required). An edge member 54 may then be secured to the panel by engaging anti-reverse fins 58 with the panel or adhering the edge member to the panel. If required, additional hardware, such as handles, connectors or the like, may be installed onto the panel.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A sandwich panel, comprising:
a pair of skins; and
at least one intermediate substrate disposed between said skins wherein said skins and said intermediate substrate are secured together to create a structural panel.

2. The sandwich panel of claim 1, wherein the material for at least one skin is selected from the group consisting of pressboard material and plastic.

3. The sandwich panel of claim 1, further including a covering material applied over at least one of said skins and forming an exterior surface of the structural panel.

4. The sandwich panel of claim 3, further including an edge member secured to a peripheral edge of the structural panel.

5. The sandwich panel of claim 4, wherein the material for said edge member is selected from the group consisting of extruded plastic and vinyl.

6. The sandwich panel of claim 1, wherein the material for at least one intermediate substrate is selected from the group consisting of wood, cardboard, plastic, metal, expanded foam, and non-expanded foam.

7. The sandwich panel of claim 4, wherein said edge member further includes at least one engaging member that mechanically engages said intermediate substrate.

8. The sandwich panel of claim 7, wherein said engaging member includes at least one anti-reverse fin extending therefrom.

9. The sandwich panel of claim 4, wherein said at least one edge member traps a portion of said covering material.

10. An automotive load-floor, comprising:
a pair of pressboard skins;
at least one intermediate substrate disposed between said skins; and
a covering material applied over at least one of said skins and forming an exterior surface of the load-floor.

11. The automotive load-floor of claim 10, further including an edge member secured to a peripheral edge of the load-floor.

12. The sandwich panel of claim 10, wherein the material for said at least one intermediate layer is selected from the group consisting of wood, cardboard, plastic, metal, expanded foam, and non-expanded foam.

13. A method of manufacturing a sandwich panel for an automobile, said method comprising:
providing at least two skins of a predetermined size and shape; and
attaching said skins to each other forming a structural panel.

14. The method of claim 13, further including providing an edge member and attaching said edge member to said structural panel.

15. The method of claim 13, further including forming said skins creating the predetermined contour of the structural panel.

16. The method of claim 13, further including attaching covering material to at least one of said skins.

17. The method of claim 16, further including attaching the covering material to at least one skin after attaching said skins to said intermediate substrate.

18. The method of claim 13, further including attaching hardware to said structural panel.

19. The method of claim 18 wherein said hardware is selected from the group consisting of a connector, hinge, and handle.

20. A method of manufacturing a sandwich panel for an automobile, said method comprising:
providing at least two skins of a predetermined size and shape;
providing at least one intermediate substrate of a predetermined size and shape;
attaching said skins to said at least one intermediate substrate creating a structural panel;
providing an edge member; and
attaching said edge member to the periphery of said structural panel.
